(19) United States
(12) Patent Application Publication
(10) Pub. No.: US 2016/0276103 A1
(43) Pub. Date: Sep. 22, 2016

(54) HIGH CAPACITANCE SINGLE LAYER CAPACITOR AND MANUFACTURING METHOD THEREOF

(71) Applicant: Knowles Cazenovia, Inc., Cazenovia, NY (US)

(72) Inventors: Prem Kumar Sood, Cazenovia, NY (US); Cassandra Nadeau, Cazenovia, NY (US); John T. Cherry, Cazenovia, NY (US); Benton O'Neil, Cazenovia, NY (US)

(73) Assignee: Knowles Cazenovia, Inc., Cazenovia, NY (US)

(21) Appl. No.: 15/037,953

(22) PCT Filed: Nov. 20, 2014
(86) PCT No.: PCT/US14/66575

§ 371 Date: May 19, 2016

Related U.S. Application Data
(60) Provisional application No. 61/907,531, filed on Nov. 22, 2013.

(51) Int. Cl. H01G 4/06; H01G 13/04

(52) U.S. Cl. CPC H01G 4/06; H01G 13/04

(57) ABSTRACT

A capacitor including a dielectric base, a metallization layer, and a very thin dielectric layer formed on one portion of the metallization layer, with an electrode formed on the dielectric layer. The method of the present invention allows for an array of capacitors to be formed so as to provide a very thin functional dielectric layer supported on a thicker dielectric substrate. The resulting capacitor has extremely high capacitance for its size.

### CROSS REFERENCE TO RELATED APPLICATION

This application claims the benefit of U.S. Provisional Application 61/907,531, filed Nov. 22, 2013, the entirety of which is incorporated herein by reference.

### FIELD OF THE INVENTION

The present invention relates to a high capacitance single layer capacitor and a method of manufacturing the capacitor.

### BACKGROUND OF THE INVENTION

Single layer capacitors have been used for decades in electronic circuits for all types of applications. More recently, it has been desired to increase the capacitance of the single layer capacitor through a more cost-effective approach without substantially increasing the overall thickness dimension, so as to maintain a low-profile on the circuit board. Prior attempts have embedded partial electrodes in a stacked fashion with interposed ceramic layers, but those approaches require too many manufacturing steps and are thus inefficient from a manufacturing standpoint. Other attempts have used vias passing through one or more layers of ceramic to provide electrical connection to one or more internal electrodes, but, again, those techniques can adversely impact manufacturing efficiency and capacitor performance at high frequency.

### SUMMARY OF THE INVENTION

An objective of the present invention is to provide a cost-effective manufacturing method for forming a high capacitance, monolithic single layer capacitor that does not encounter the manufacturing inefficiencies associated with the prior art.

One embodiment of the present invention is a capacitor comprising a dielectric base having three pairs of opposed side surfaces, a metallization layer of uniform thickness formed contiguously on two of the three pairs of opposed side surfaces, a dielectric layer formed on a portion of the metallization layer that covers one side surface of the two pairs of opposed side surfaces, and an electrode formed on the dielectric layer.

The thickness of the dielectric layer can be 0.2 mil-2.0 mil (inclusive of all 0.10 mil increments within this range), the thickness of the dielectric base can be 5 mil-15 mil (inclusive of all 0.10 mil increments within this range), and the thickness of the metallization layer can be 0.1 mil-4 mil (inclusive of all 0.10 mil increments within this range).

A ratio of the thickness of the dielectric base to the thickness of the dielectric layer is at least 5:1, preferably 10:1, more preferably 20:1, most preferably 50:1. The dielectric base and dielectric layer is preferably made of the same or different ceramic material, preferably selected from the group consisting of class I and class II ceramics.

In one embodiment, the remaining pair of opposed side surfaces are defined by exposed portions of the dielectric base.

In another embodiment, the dielectric layer is formed by multiple layers of green ceramic material that are laminated and co-fired to form a unitary layer.

In another embodiment, the area of the upper surface of the electrode is less than the area of the upper surface of the dielectric layer.

A method of forming a capacitor according to the present invention comprises:

providing a dielectric substrate having an array of apertures formed therethrough, each aperture having two opposed side walls extending from a first surface of the dielectric substrate to an opposed second surface thereof;

depositing a conductive material on the first surface of the dielectric substrate so as to form a conductive coating that extends between adjacent pairs of apertures and extends along the opposed side walls of each aperture a distance greater than one-half the thickness of a dielectric substrate;

depositing a conductive material on the second surface of the dielectric substrate so as to form a conductive coating that extends between said adjacent pairs of apertures and extends along the opposed side walls of each aperture a distance greater than one-half the thickness of the dielectric substrate, whereby the conductive coating formed on the first surface of the dielectric substrate and the conductive coating formed on the second surface of the dielectric substrate contact one another to form a contiguous metallization layer of uniform thickness;

forming a dielectric layer on the first surface of the dielectric substrate to cover that portion of the metallization layer that is formed on the first surface of the dielectric substrate;

forming an electrode on said dielectric layer at a position between said adjacent pairs of apertures to form a subassembly;

singulating the subassembly to form a plurality of ceramic capacitors; and

firing the ceramic capacitors.

In one embodiment, each aperture is an elongated slot having a length dimension L and a shorter width dimension W, and the adjacent pairs of apertures are spaced apart from one another by a distance S, wherein L and S are in a range of 20 mil-120 mil, and W is about two times the thickness of the dielectric substrate.

In one embodiment, the conductive material is a conductive ink having a viscosity of 10 Kcps-50 Kcps, preferably 20 Kcps-30 Kcps. In particular, the viscosity of the conductive ink is selected such that the conductive ink extends along the opposed side walls of each aperture a distance of at least ⅔ the thickness of the dielectric substrate.

In another embodiment, the conductive material is deposited so as to cover the entire first and second surfaces of the dielectric substrate.

The dielectric layer can tape cast on a carrier, laminated on the first surface of the dielectric substrate, and then the carrier is removed. In addition, the dielectric layer can be formed as multiple layers on the first surface of the dielectric substrate, and then isostatically pressed. In this case, the multiple layers forming the dielectric layer are integrated into a unitary layer after the firing step.

The dielectric substrate can also be formed as a plurality of tape cast layers that are laminated and isostatically pressed together.

### BRIEF DESCRIPTION OF THE DRAWINGS

FIG. 1 depicts a dielectric substrate having a plurality of slots formed therethrough;

FIG. 2A shows two adjacent pairs of slots in the dielectric substrate having metallizations formed thereon;

FIG. 2B is similar to FIG. 2A, except the metallization layer is formed as a contiguous layer covering the entire surface of the dielectric substrate;

FIGS. 3A and 3B are cross-sectional views taken through lines 111A-111A and 111B-111B of FIGS. 2A and 2B, respectively;

FIG. 4 is the same cross-sectional view as FIG. 3B, but with a ceramic layer formed on an upper surface of the metallization layer;

FIG. 5 shows the formation of isolated electrodes on the ceramic layer;

FIG. 6 shows the cutting lines used to singulate the capacitors;

FIG. 7 is a perspective view of a singulated capacitor; and

FIG. 8 is a view of a capacitor according to another embodiment of the present invention.

### DETAILED DESCRIPTION OF THE INVENTION

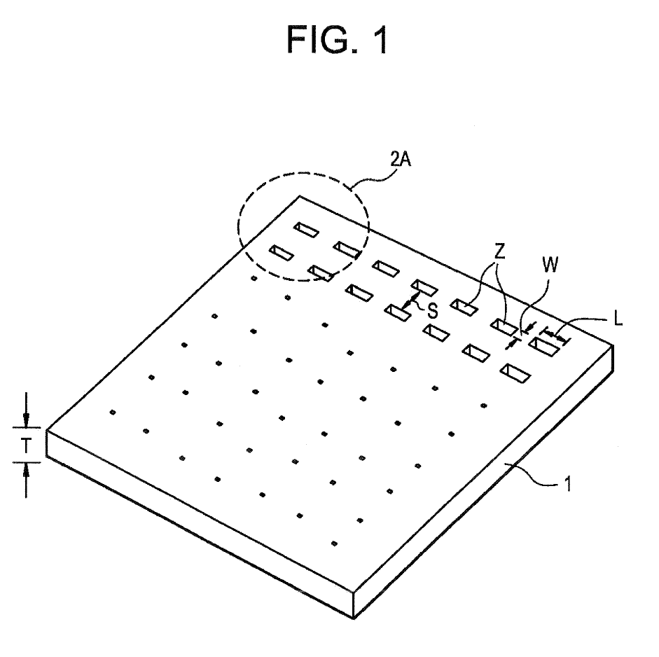

FIG. 1 depicts a dielectric substrate 1 having a plurality of elongated slots 2 forward therethrough an array across the substrate 1. For the sake of simplicity, the dots in FIG. 1 represent the position of the remaining consecutive rows of slots 2. The size of the substrate 1 is limited only by the machinery available for manufacturing and by the amount of mechanical distortion tolerable within the substrate. Regarding the former, some punching and printing machines, such as those sold by Baccini, can handle 12″×12″ green sheets, whereas other industrial machines are limited to 5″×5″ green sheets. Regarding the latter, the more slots that are punched, the more the substrate will mechanically distort by either stretching or contracting due to the non-uniform removal of material. In addition, the size of each slot will contribute to the mechanical distortion of the substrate. Thus, the greatest number of slots should be formed through the substrate to maximize production efficiency, but the number should be limited so as to minimize mechanical distortion of the substrate.

In a preferred embodiment, the dielectric substrate 1 is fabricated from a plurality of ceramic greet sheets that are laminated together. Any known method can be used to form the dielectric substrate 1, although the material for the substrate is preferably ceramic.

In addition, while the dielectric substrate could be fired at this point in the process, it is preferred to maintain the substrate in a green state so that the final capacitor can be co-fired in a single step, as explained later herein.

In the case of forming the dielectric substrate 1 using laminated ceramic green sheets, such green sheets can be formed by any known method, such as tape casting, for example. A typical thickness range for the cast green sheets is from 1-5 mil (thinner green sheets could be used, but an unrealistically large number of sheets would be necessary to build a mechanically robust substrate). The green sheets are then laminated to form a base layer thickness that can be any value, but is typically between 5 mil to 15 mil, preferably 8 mil to 10 mil. While the use of thicker, individual green sheets would reduce the number of sheets necessary to form the dielectric substrate 1, most tape casting materials are designed by manufacturers to be cast in thin sheets on the order of 1 mil or less. As such, one example would be to use ten 1-mil sheets to form a dielectric substrate of roughly 10 mil in thickness.

In one embodiment, the green sheets are tape cast on Si impregnated Mylar film, dried and then wound on a roll. Each sheet is cut from the roll and left on the Mylar film until after tack pressing. The first two sheets are pressed dull side to dull side for an extended period of 2 minutes at 35 tons force. After the initial tack press, the Mylar film is peeled away from one side of the currently 2 mil thick assembly. Each subsequent sheet is laminated by taking a piece of tape still on the Mylar film, placing it onto the assembly with the Mylar film facing out, and tack pressing for 30 seconds at 35 tons force. The Mylar film is removed before the next sheet is laminated. After tack pressing, the Mylar film is peeled from the last, upper layer of the stack. Of course, all of the ceramic layers could be stacked and the respective Mylar sheets removed before performing a single tack pressing. Once 10 sheets have been tack pressed, the entire assembly is trimmed down to 5″×5″. Finally, the assembly is isostatically pressed.

The isostatically pressed assembly is then exposed to a pretreating cycle in an oven, for example, at 100° C. for 3 hours. This cycle serves to both stiffen as well as predistort the plate prior to processing further. This step is helpful in achieving reasonable distortion, which allows for small edge borders and high capacitance in the final fired assembly.

The binder system used in the green sheets depends upon the ceramic material that makes up the green sheets. Suffice it to say, the binder system should be selected so as to minimize mechanical distortion of the dielectric substrate during subsequent processing.

The shape and size of the slots 2 is not particularly limited, although the slots should be elongated as depicted in FIG. 1 to facilitate transport of a screen printed conductive material (described later) down the side walls of each slot. The longitudinal dimension (L) of the slot and the spacing (S) between slots depends upon the specific dimensions of the final capacitor chip (D10 (10 mil×10 mil)-D90 (90 mil×90 mil)). The length of the slot L should be a minimum of 10 mil longer than that of the final singulated capacitor. This is to prevent the clinging of ink in the corner or end of the slot from causing an irregularly shaped final part. Consequently, L and S, which are approximately equal, typically range from 20 mil to 120 mil. The lateral dimension of the slot W is required to be wide enough to ensure that only a coating of ink is formed on the side walls of the slots (described in more detail below). In general, the dimension W can be approximately related to the base thickness T with a relationship of W=2T. Again, a wider slot is preferred to ensure that the slot is not clogged with ink as any bridging of ink within the slot from one side wall to the other will result in an irregularly shaped final capacitor. The disadvantage of too wide of a slot is that it will contribute to overall distortion of the substrate 1. The distortion of this substrate 1 will contribute to mechanical error in subsequent steps. It is preferred that the sides of the slot are planar, as those sides will define the sides of the resulting, singulated capacitor chips (described later). The slots can be formed using known punching machines with custom die sets that are fabricated based on the intended size and shape of the slots.

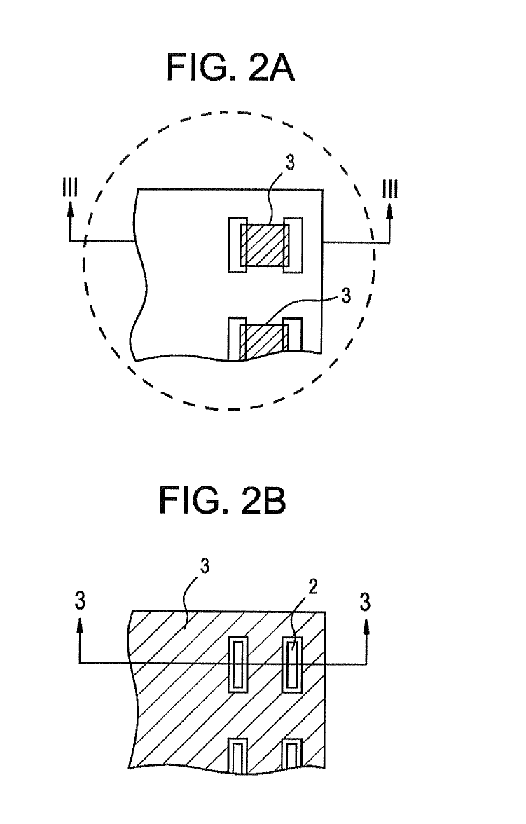

FIG. 2A shows a portion of FIG. 1, but with metallizations 3 formed (by screen printing, for example) on the upper surface of substrate 1 so as to bridge each adjacent pair of slots 2. The openings in the screen should, in general, be of width S+W. The size of the openings may need to be modified in width to account for mechanical distortion of the substrate in order to guarantee that the side walls of the slots are coated with the metallization material (e.g., a conductive ink), but not clogged completely. The viscosity of the conductive material used to form metallizations 3 and the dimensions of the slots 2 are selected such that, during the coating process, the conductive material covers not only the upper surface of substrate 1 between the slots 2, but also extends down at least two-thirds the thickness of the side walls of each of the slots 2. The metallization typically has a thickness ranging from 0.1 mil to 2 mil (inclusive of every 0.10 mil increment within this range) on the top of the part and 1 mil-4 mil (inclusive of every 0.10 mil increment within this range) on the side walls.

The rheological properties of the ink, specifically the viscosity, need to be tailored to provide a thick enough coating of ink at the corner formed by the top of the sheet and the side wall of the slot. Ideally the thickness of ink at the corner should be >0.25 mil. The viscosity of the ink needs to be controlled so as to ensure the ink coats the side walls of the slots without fully filling the slots or partially clogging the slots. Clogged slots will produce irregularly shaped final parts which are undesirable. The viscosity of the ink should range from 10 Kcps-50 Kcps, preferably 20 Kcps-30 Kcps. In one example of the present invention, W=12 mil, L=70 mil, S=48 mil and the conductive ink has a viscosity of 25 Kcps.

In one preferred embodiment, the top side of the ceramic substrate 1 is screen printed twice with the conductive ink, with a short drying cycle between the two printing steps. This ensures a full wraparound from the top surface of the ceramic substrate down at least two-thirds the thickness of the side walls of each slot 2.

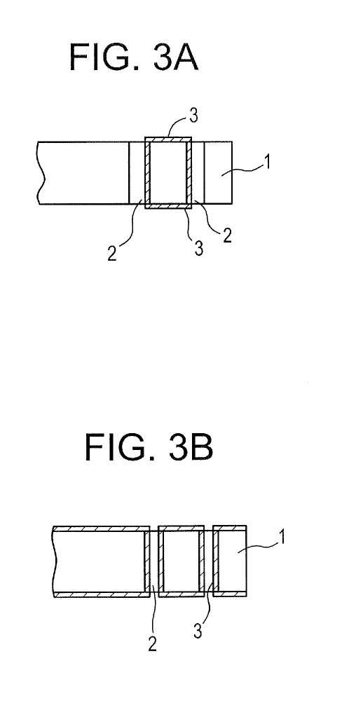

After drying the ink for the second time, the substrate 1 is inverted and the same amount of conductive material is applied to the lower surface of substrate 1 so as to bridge each of the same adjacent pairs of slots 2 as on the upper surface. Again, the viscosity of the conductive material and the dimensions of the slots 2 are selected such that the conductive material will cover not only the lower surface of substrate 1, but also extend down greater than one-half, preferably at least two-thirds the thickness of the walls of slots 2, with the result being a contiguous conductive layer formed on the upper and lower surfaces of substrate 1 between each adjacent pair of slots 2 and along the entire inner walls of the adjacent slots 2 (as depicted in FIG. 3A). Although not, necessary, it is preferred to perform two prints from the bottom side of the ceramic substrate with a drying cycle performed between prints, as well as a drying cycle after the second print. As an alternative, the entire upper and lower surfaces of substrate 1 can be printed with the conductive material, as shown in FIGS. 2B and 3B, to achieve a similar result to that depicted in FIGS. 2A and 3A, respectively.

It is also possible to pre-fill the slots completely with the conductive material (by stencil printing, for example) before the upper and lower metallizations 3 are formed. This ensures a contiguous metallization is formed on the inner walls of the slots in electrical contact with the upper and lower metallizations 3.

It is also possible to apply the ink to the substrate 1 while pulling a slight vacuum from below the substrate. This would assist in ensuring that the ink enters and coats the opposed side walls of each slot. A standard vacuum chuck could be used for this step, although some type of filter barrier (a piece of foam or felt) would have to be positioned between the substrate 1 and the vacuum chuck to prevent the ink from entering the holes in the vacuum chuck.

According to another embodiment, a single elongated slot could be formed to extend across the entire length (along the L dimension in FIG. 1), instead of individual slots formed in each row. In such a case, there would be no wasted material when the chips are singulated (described later) because each singulation line (along the W dimension in FIG. 1) would define the final side surfaces of two adjacent chips.

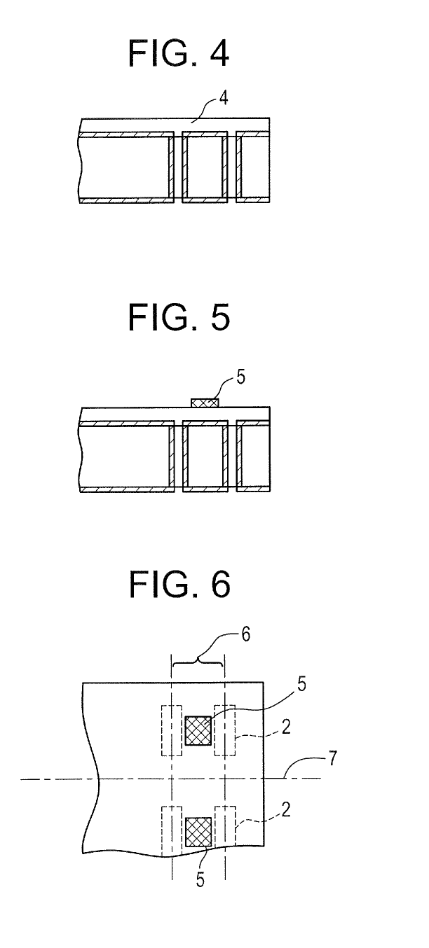

FIG. 4 shows that a ceramic layer 4 is then formed over the entire upper surface of the sub-assembly shown in FIG. 3B (with the understanding that the ceramic layer 4 could instead be formed over the entire upper surface of the sub-assembly shown in FIG. 3A). The thickness of the ceramic layer 4 can range from 0.2 mil to 2.0 mil (inclusive of every 0.10 mil increment within this range) and is dictated by the target capacitance of the resulting capacitor chips and the dielectric constant of the ceramic material making up ceramic layer 4. The ceramic layer 4 can be formed from 1 mil ceramic tape, for example, that is laminated on the upper surface of green sheet 1 so as to cover the upper surface and metallizations 3.

Since the thickness of the ceramic layer 4 dictates the capacitance of the final capacitor, the thinner the ceramic layer, the higher the capacitance of the final, singulated capacitor. In one preferred embodiment, the ceramic layer is deposited as a pre-formed green sheet having a thickness of about 0.2-0.3 mil. In a more preferred embodiment, at least two of these thin green sheets are laminated to form ceramic layer 4 (after firing). The advantage of using at least two thin green sheets is to ensure that, if a defect exists in one of the sheets, the odds of a defect existing in the same location in the other sheet are almost nil. As such, after firing, the presence of one monolithic, contiguous ceramic layer at all points along the capacitor can be guaranteed. Regardless of how many green sheets are used, after firing there is only one ceramic layer defining the capacitance in the final product.

In order to laminate ceramic layer 4 on the upper surface of the sub-assembly as shown in FIG. 4, a preferred method is to use a ceramic tape that has already been cast onto an Si impregnated Mylar film. For example, a piece of tape is cut from a roll of the ceramic tape/Mylar film that is approximately 4″×4″. This tape is left on the Mylar film, and placed on the sub-assembly (see FIG. 4) with the Mylar film facing outward. The sub-assembly is then tack pressed for 30 seconds at 35 ton force, for example. The tack pressing step can be omitted if it creates too much distortion in the ceramic layer 4 or the sub-assembly as a whole. After the Mylar film is peeled from the assembly, the entire sub-assembly is isostatically pressed.

Alternatively, a ceramic paste could be screen printed to cover the upper surface of substrate 1, which would allow the thickness of layer 4 to be reduced even further, with a consequent increase in capacitance value in the resulting capacitor. The paste would be printed with either a stencil or screen in order to ensure that no paste is deposited into the open slots. Any paste deposited into the open slots would prevent the end user from connecting to the base of the capacitor electrically. In the case of printing layer 4 using a paste, it is possible to use a pre-fired ceramic for the ceramic base sheet 1. The slots 2 would be formed through the fired ceramic base sheet 1 by machining (e.g., laser machining or diamond saw dicing).

The dielectric constant of the ceramic layer 4 is dictated by the composition of the material making up the ceramic layer 4. There are numerous commercially available ceramic materials that could be used, with the dielectric constant of such materials typically ranging from 35 to 4,000. It is also possible for ceramic layer 4 to be made of an extremely high dielectric ceramic material that is loaded with a conducting material or metal, in which case the ceramic layer 4 can have a dielectric constant as high as 60,000.

FIG. 5 shows that isolated electrodes 5 are then formed (by screen printing, for example) between each pair of slots 2 in the green sheet 1. The electrodes 5 typically have a thickness ranging from 0.1 mil to 1 mil (inclusive of every 0.10 mil increment within this range). The overall size of the electrode is sized to provide a small ceramic border around the perimeter of the final part. This border ensures an adequate voltage rating of the final, singulated capacitor. The size of the border should be based upon the measured distortion of the ceramic substrate. Depending on the magnitude and repeatability of the mechanical distortion of the ceramic substrate, one could scale the position of the windows in the screen geometry associated with the position of the electrodes 5. This scaling could be done either outward or inward from the center to compensate for possible mechanical errors. In order to quantitatively measure the mechanical distortion of the ceramic substrate throughout the process steps, one can use an array of fiducials spread throughout the slot pattern. This measurement and adjustment can either be done dynamically on every plate, or statically on test plates and then assumed to be repeatable.

FIG. 6 shows that the sub-assembly is then diced laterally through each row of slots 2 (the slots 2 are shown by short dotted lines in FIG. 6) along lines 6 and also longitudinally between each column of slots 2 along lines 7 to isolate each portion of the sub-assembly. Alternatively, a punch could be used to singulate the capacitors (the size of each punch would be about equal to the rectangles formed by intersecting pairs of lines 6 and 7 surrounding electrodes 5). The final dicing or punching should be sized such that the height is equal to the height of the final, singulated capacitor. The width of the final punch should be sized such that it extends into each slot on either side of the part by a minimal amount of S/4. Due to the mechanical distortion within the ceramic substrate, the punch must be sized to be greater than the width of the singulated capacitor plus S. This is to ensure that the punch does not damage any of the conductive wraparounds, which would cause either an irregularly shaped or unreliable final part. In fact, if there is lateral distortion in the sub-assembly, the punching machine itself is sophisticated enough to ensure that the punches line up with the locations of the parts to be singulated on the sub-assembly. In one embodiment, a mild tumbling step is used to remove any portion of the thin top layer of ceramic 4 that extends from the edge of the part to where the part was diced or punched. This is a product of the punch occurring somewhere in the slot.

It would also be possible to dice the sub-assembly of FIG. 6 such that multiple capacitors are still linked to one another as a common unit. This would allow for wider latitude in circuit board design, for example.

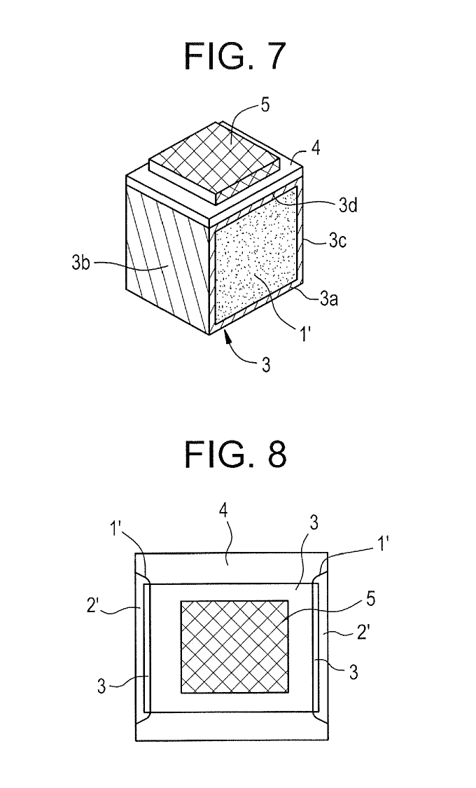

The result of the dicing or punching operation is a plurality of singulated parts that are then pre-baked for 36 hours, for example, for binder burn out, and then fired to form the final high capacitance single layer capacitor chips ready for use (see FIG. 7). It is also possible, of course, to burn out the binder as part of the firing operation, so that a single firing step is employed.

The sizes of the capacitor chips range from D10 to D90, with the most common sizes being D25 (25 mil×25 mil), D35 (35 mil×35 mil) and D40 (40 mil×40 mil). The materials for the ceramic layer 4 and the thickness thereof can be selected so as to provide capacitance values ranging from 10 pF all the way up to 10,000 pF.

One of the singulated capacitor chips is depicted in FIG. 7. The chip includes the fired ceramic base 1′ having the metallization 3 formed around the entire perimeter thereof, leaving two opposed side faces exposed. The lower surface 3a of metallization 3 serves as the ground plane for the capacitor chip when mounted on a circuit board. The side surfaces 3b, 3c of metallization 3 serve to connect the ground plane to the metallization 3d on the upper surface of ceramic base 1, which serves as the lower electrode of the single layer capacitor.

One very significant advantage to having the metallization extend all the way around the perimeter of the ceramic base 1, with the opposed side surfaces exposed, is that the upper metallization 3d, which serves as the lower electrode for the capacitor chip, is connected to the ground plane by both side metallizations 3b, 3c, thereby effectively reducing the parasitic inductance associated with the chip by about 50%. This reduction in inductance significantly improves the performance of the chip at high frequencies (e.g., >1 GHz).

Although FIG. 7 shows the two side surfaces of ceramic base 1 on which the metallized layers are formed as being parallel to one another, it is more likely that both side surfaces will resemble some portion of the original slots 2 (see surfaces 2′ in FIG. 8) that were punched through the green sheet 1. For example, when viewing the capacitor chip from the top, those side surfaces 2′ may cause a significant vertical portion of the capacitor chip to have somewhat of an I-beam configuration. In this case, the metallizations 3 on the side surfaces would not extend over the entire width (the up-and-down direction in FIG. 8) of the capacitor chip. While the side surfaces of ceramic base 1 and side surface metallizations 3 are depicted in FIG. 8 for ease of understanding, in actuality the ceramic layer 4 would shield those parts from sight when viewed from the top.

While the present invention can be used with any known high dielectric ceramic materials and conductive materials, it is preferred that the ceramic material for the substrate 1 and capacitor layer 4 is selected from Ultra Low Fire (ULF) ceramics using an LTCC (low temperature cofired) technique. Different ceramic materials could be used and an HTCC (high temperature cofired) technique could be used, in which case the metallizations 3 and electrodes 5 would be made from a higher temperature metal, such as tungsten.

For example, depending upon the desired capacitance of the final product, the dielectric ceramic materials can be selected from class I or class II materials, with an X7R class II material being preferred (because it has a dielectric constant that fluctuates only +/−15% from −55° C. to +125° C.). Examples of specific classes of materials that work particularly well are BaTiO₃ (doped with Bi, for example), UX type materials such as Ba/SrTiO₃, Ca—Cu-doped titania systems (e.g., CaCu₃Ti₄O₁₂), and Nb—In-doped TiO₂ systems.

While it is preferred to use the same material for the ceramic substrate 1 and capacitor layer 4 from the perspective of matching the thermal expansion coefficients of the two materials, since the ceramic substrate 1 simply serves as a mechanical support, any insulating ceramic material could be used. Again, thermal expansion coefficient differentials would have to be taken into account when selecting the material for the ceramic substrate 1.

It is also preferred that the conductive material for metallizations 3 and top electrodes 5 is AgPd, for example, 90Ag10Pd. This material is compatible with a ULF dielectric. The use of an all AgPd ink system allows use of dielectrics, other than ULF materials, to form the ceramic substrate 1 and capacitor layer 4. One advantage of using ULF materials, however, is that, by keeping the firing temperature of the ceramic lower, an ink with a greater Ag concentration can be used thus keeping the cost of the ink down.

Finally, while the material for upper electrodes 5 is selected from known conductive electrode materials to which termination leads can be easily connected, the use of wire bondable Au is not suitable due to the AgPd of metallizations 3 diffusing into the Au and creating and alloy not suitable for wirebonding. Wirebonding would be the primary reason that an Au top electrode would be used. By using an AgPd ink rather than a top Au electrode, the final capacitor would have to be plated with another conductive material (e.g., Ni and then Au after firing). The material used for the upper electrodes in most cases is dictated by the end use (i.e., by the customer).

Ceramic firing is usually carried out within a temperature range of 900-1,300° C. with a preferred range when using a ULF ceramic of between 930-950° C., well below the melting point temperature of the conductive materials for metallizations 3 and electrodes 5. The firing should continue for a time sufficient to achieve complete sintering of ceramic base 1 and ceramic layer 4 (e.g., 2-4 hours). Other known firing techniques can be employed as well, depending upon the materials selected for capacitor layer 4, base layer 1 and the materials for metallizations 3.

The present invention provides a highly efficient manufacturing process for forming single layer capacitors that exhibit a wide range of capacitance values. By using slots 2 that define the sides of the final capacitor while also acting as surfaces on which metallizations 3 can be easily formed, it is possible to form a conductive shell around four of the six exposed surfaces of the capacitor chip using a simple manufacturing process that does not require more than a few steps. Moreover, forming the ceramic layer 4 above the metallizations 3 allows for a wide latitude in product design to meet a variety of capacitance requirements, by simply changing the thickness of the ceramic layer 4, without having to make substantial changes to the overall manufacturing process.

What is particularly impressive about the capacitor of the present invention is that the thickness of the functional, ceramic layer 4 can be made very thin compared to the thickness of the ceramic substrate 1, and compared to the functional, ceramic layers of prior art capacitors. For example, the thickness ratio of the ceramic substrate 1 to the ceramic layer 4 can easily exceed 5:1, 10:1, 20:1 and even 50:1. As such, the thickness of the ceramic substrate 1 can be selected to provide sufficient mechanical support, while the thickness of the ceramic layer 4 can be made incredibly thin to provide a singulated capacitor of extremely high capacitance, especially for its size.

One specific example of the present invention is as follows:

### Example

1) Build substrate using ten 1 mil thick sheets of Ferro ULF272:
   a. Tack press at 60 kPSI for 10 mins at 45° C.;
   b. Isostatically press at 2 kPSI for 45 sec at 45° C.;
2) Pretreat substrate at 100° C. for 3 hours;
3) Punch an array of equally spaced 1666 slots that are W×L×S=12 mil×70 mil×48 mil;
4) Print upper surface of substrate with Heraeus CL40-10606 (to a thickness (“t”) about 0.4 mil on upper surface and about 0.3 mil (“t”) on side walls of slots);
5) Dry in tunnel dryer for 10 min at 85° C. (t about 0.35 mil; t′ about 0.25 mil);
6) Print upper surface again with Heraeus CL40-10606 (thicknesses same as in step 4);
7) Dry in tunnel dryer for 10 min at 85° C. (final t on upper surface about 0.7 mil; final ti on side walls of slots about 0.5 mil);
8) Invert substrate and print lower surface with Heraeus CL40-10606 (thicknesses same as in step 4);
9) Dry in tunnel dryer for 10 min at 85° C. (thicknesses same as in step 5);
10) Print lower surface again with Heraeus CL40-10606 (thicknesses same as in step 4);
11) Dry in tunnel dryer for 10 min at 85° C. (final t on lower surface about 0.7 mil; final t on side walls of slots about 1.0 mil);
12) Transfer 0.8 mil thick ULF272 tape cast sheet onto upper surface of sub-assembly;
13) Isostatically press at 2 kPSI for 45 sec at 45° C.;
14) Print 90Ag10Pd top electrodes with size of 38 mil×38 mil (t about 0.4 mil);
15) Dry in tunnel dryer for 10 min at 85° C. (t about 0.35 mil);
16) Punch out final parts with dimension of 48 mil×48 mil; and
17) Fire in box kiln with peak temperature of 940° C. with soak time of 4 hours.
   The final, singulated capacitors had a capacitance in the range of 800 pF-1200 pF with a finished part size of a D35 (35 mil×35 mil)+/−5 mil. The thickness of the fired metallizations on the upper and lower surfaces was about 0.15 mil-0.20 mil and the thickness of the fired metallizations on the side walls of the slots was about 0.4 mil-0.5 mil.

While the present invention has been particularly shown and described with reference to the preferred mode as illustrated in the drawing\s, it will be understood by one skilled in the art that various changes in detail may be effected therein without departing from the spirit and scope of the invention as defined by the claims.

1. A capacitor comprising:
a dielectric base having three pairs of opposed side surfaces;
a metallization layer of uniform thickness formed contiguously on two of the three pairs of opposed side surfaces;
a dielectric layer formed on a portion of the metallization layer, wherein the portion of the metallization layer covers one side surface of the two pairs of opposed side surfaces; and
an electrode formed on the dielectric layer.

2. The capacitor of claim 1, wherein a thickness of the dielectric layer is in a range of 0.2 mil-2.0 mil, 5 mil-15 mil, or 0.1 mil-4 mil.

3. (canceled)

4. (canceled)

5. The capacitor of claim 1, wherein a ratio of a thickness of the dielectric base to a thickness of the dielectric layer is at least one of: 5:1, 10:1, 20:1, or 50:1.

6. The capacitor of claim 1, wherein the dielectric base and dielectric layer are made of a ceramic material.

7. (canceled)

8. The capacitor of claim 6, wherein the ceramic material is selected from a group consisting of class I and class II ceramics.

9. The capacitor of claim 1, wherein a remaining pair of opposed side surfaces are defined by exposed portions of the dielectric base.

10. The capacitor of claim 1, wherein the dielectric layer is formed by multiple layers of green ceramic material that are laminated and co-fired to form a unitary layer.

11. The capacitor of claim 1, wherein an area of an upper surface of the electrode is less than an area of an upper surface of the dielectric layer.

12. A method of forming a capacitor, comprising:
providing a dielectric substrate having an array of apertures formed therethrough, each aperture having two opposed side walls extending from a first surface of the dielectric substrate to an opposed second surface thereof;
depositing a conductive material on the first surface of the dielectric substrate so as to form a first conductive coating that extends between adjacent pairs of apertures and extends along the opposed side walls of each aperture a distance greater than one-half the thickness of a dielectric substrate;
depositing a conductive material on the second surface of the dielectric substrate so as to form a second conductive coating that extends between said adjacent pairs of apertures and extends along the opposed side walls of each aperture a distance greater than one-half the thickness of the dielectric substrate, whereby the first conductive coating and the second conductive coating contact one another to form a contiguous metallization layer of uniform thickness;
forming a dielectric layer on the first surface of the dielectric substrate to cover a portion of the metallization layer, wherein the portion of the metallization layer is formed on the first surface of the dielectric substrate;
forming an electrode on the dielectric layer at a position between the adjacent pairs of apertures to form a subassembly;
singulating the subassembly to form a plurality of ceramic capacitors; and
firing the ceramic capacitors.

13. The method of claim 12, wherein each aperture is an elongated slot having a length dimension L and a shorter width dimension W, wherein adjacent pairs of apertures are spaced apart from one another by a distance S, wherein L and S are in a range of 20 mil-120 mil, and wherein W is about two times the thickness of the dielectric substrate.

14. The method of claim 12, wherein the conductive material is a conductive ink having a viscosity in a range of 10 Kcps-50 Kcps, or 20 Kcps-30 Kcps.

15. (canceled)

16. The method of claim 12, wherein the conductive material is a conductive ink and a viscosity of the conductive ink is selected such that the conductive ink extends along the opposed side walls of each aperture a distance of at least ⅔ the thickness of the dielectric substrate.

17. The method of claim 12, wherein the conductive material is deposited so as to cover the entire first and second surfaces of the dielectric substrate.

18. The method of claim 12, wherein the forming of the dielectric layer on the first surface of the dielectric substrate comprises:
tape casting the dielectric layer on a carrier;
laminating the carrier on the first surface; and
removing the carrier.

19. The method of claim 18, wherein the dielectric layer is formed as multiple layers on the first surface of the dielectric substrate, and then isostatically pressed.

20. The method of claim 19, wherein the multiple layers forming the dielectric layer are integrated into a unitary layer after the firing step.

21. The method of claim 12, wherein the dielectric substrate is formed as a plurality of tape cast layers that are laminated and isostatically pressed together.

22. The method of claim 12, wherein the dielectric substrate and dielectric layer are made of a ceramic material.

23. (canceled)

24. The method of claim 22, wherein the ceramic material is selected from a group consisting of class I and class II ceramics.

25. The method of claim 12, wherein the dielectric substrate has a thickness in a range of 5 mil-15 mil, 0.2 mil-2.0 mil, or 0.1 mil-4 mil.

26. (canceled)

27. (canceled)
